(19) United States
(12) Patent Application Publication
(10) Pub. No.: US 2014/0352554 A1
(43) Pub. Date: Dec. 4, 2014

(54) DUAL-LAYER FILTER NET AND JUICER USING THE SAME

(71) Applicant: Kwonnie Electrical Products Limited, Hong Kong (HK)

(72) Inventors: Chung Leung Chau, Hong Kong (HK); Xiao Ming Zhou, Changde (CN)

(73) Assignee: Kwonnie Electrical Products Limited, Hong Kong (HK)

(21) Appl. No.: 14/272,527

(22) Filed: May 8, 2014

(30) Foreign Application Priority Data
May 29, 2013 (CN) 201320301847.4

(51) Int. Cl. B01D 29/085; A23N 1/02

(52) U.S. Cl. CPC B01D 29/085; A23N 1/02
USPC 99/513; 210/497.3

(57) ABSTRACT

A dual-layer filter net and a juicer that uses the same are provided. The juicer includes a housing, a cutter plate, a driving device and a dual-layer filter net. The dual-layer filter net includes an inner layer filter net and an outer layer filter net. The opening of the inner layer filter net faces upward and the opening of the outer layer filter net faces downward. A residue extraction gap is formed between the inner layer filter net and the outer layer filter net. The material undergoes the first juice extraction by the inner layer filter net and the residues expelled undergoes the second juice extraction by the outer layer filter net.

### CROSS-REFERENCE TO RELATED APPLICATIONS

This present application claims the benefit of Chinese patent application No. 201320301847.4 filed on May 29, 2013; the contents of which are hereby incorporated by reference.

### TECHNOLOGY FIELD

The present patent application relates to a filter net, and particularly relates to a dual-layer filter net and a juicer using the same.

### BACKGROUND

A juicer is a machine that can perform mixing and liquid squeezing of fruits or vegetables. The juice squeezed from the juicer has a better nutritional value and taste than that purchased from the open market. Therefore, it is favored by the consumers.

During the operation, the juicer applies a centrifugal force to separate the residue and the juice. The magnitude of the centrifugal force is related not only to the motor, but also is related to the angle between the filter net slanted surface and the horizontal surface. The larger it is of the angle, the slower it is in the deceleration of the centrifugal force towards the juice and the residue, and the higher it is in the rate of amount of juice extracted.

The conventional angle between the filter net slanted surface and the horizontal surface is generally only 45˜60 degrees. The angle cannot exceed 90 degrees in maximum. Otherwise, the residue cannot be released out smoothly. Furthermore, the filter net in the juicer in the current market mostly uses a single layer filter net. During the operation of the juicer, the remaining residue of the material being grinded still contains large amount of juice after being filtered by the single layer filter net. These residues that contain the juice would fly out under the effect of the centrifugal force and cause waste. Even though there are dual-layer filter net juicers in the current market, those inner and outer dual-layer filter net or upper and lower dual-layer filter net are still in the conventional funnel shape tapered from top to bottom. Further, the inner and outer dual-layer filter net or upper and lower layer filter net are all in the same direction, with only different angles between the dual-layer filter nets slanted surface and the horizontal surface.

### SUMMARY

According to one aspect of the patent application, a dual-layer filter net is provided. The dual-layer filter net includes a concaved-shaped inner layer filter net including a first opening facing upwards and a concaved-shaped outer layer filter net including a second opening facing downwards. The outer layer filter net is located at a top of the inner layer filter net. The first opening is located within the outer layer filter net. An external circumference of the first opening and an internal wall of the outer layer filter net form a residue extraction gap therebetween.

In one embodiment, the inner layer filter net is in a funnel shape that tapers from top to bottom. The outer layer filter net is in a funnel shape that tapers from bottom to top.

In one embodiment, the maximum external diameter of the inner layer filter net is less than or equal to the minimum internal diameter of the outer layer filter net.

According to another aspect of the patent application, a juicer is provided. The juicer includes a dual-layer filter net, a housing, a cutter plate and a driving device. The dual-layer filter net includes a concaved-shaped inner layer filter net including a first opening facing upwards and a concaved-shaped outer layer filter net including a second opening facing downwards. The housing includes a juice opening, a material inlet cavity, a residue collecting cavity, a first juice collecting cavity, and a second juice collecting cavity. The outer layer filter net is located at a top of the inner layer filter net. The first opening of the inner layer filter net is located within the outer layer filter net. An external circumference of the first opening of the inner layer filter net and an internal wall of the outer layer filter net form a residue extraction gap therebetween. The dual-layer filter net, cutter plate and driving device are mounted inside the housing. The cutter plate is located within the inner layer filter net. The driving device is configured to drive the cutter plate to rotate. The material inlet cavity is located at a central top of the cutter plate and connects to an internal part of the inner layer filter net. The residue collecting cavity is located at a bottom of the residue opening gap and connects to the residue opening gap. The first juice collecting cavity is located at a bottom of the inner layer filter net. The second juice collecting cavity is located at an external area of the outer layer filter net. The first juice collecting cavity and the second juice collecting cavity both connect to the juice opening.

In one embodiment, the internal bottom surface of the second juice collecting cavity includes a ring shaped juice collecting groove. The external side of the interior wall surface of the ring shaped juice collecting groove and the external side of the interior wall surface of the second juice collecting cavity align.

In one embodiment, the juicer further includes a pusher rod being provided in the material inlet cavity.

### BRIEF DESCRIPTION OF THE DRAWINGS

FIG. 1 illustrates a juicer according to an embodiment of the present patent application.

FIG. 2 is a cross sectional view of the juicer according to the embodiment of the present patent application.

FIG. 3 is an exploded view of the juicer according to the embodiment of the present patent application.

FIG. 4 is a perspective view of a dual-layer filter net according to the embodiment of the present patent application.

FIG. 5 is a cross sectional view of the dual-layer filter net according to the embodiment of the present patent application.

### IN THE DRAWINGS

| | |
|---|---|
| 10: housing | 11: main body |
| 12: first juice collecting cap | 13: second juice collecting cap |
| 14: upper cap | 15: handle |
| 16: pusher rod | 17: cap body |
| 18: left and right safety arms | 19: material inlet tube ring |
| 101: juice outlet | 102: material inlet cavity |
| 103: residue collecting cavity | 104: first juice collecting cavity |
| 105: second juice collecting cavity | 106: ring shaped juice collecting |
| | groove |
| 20: cutter plate | 30: driving device |
| 40: dual-layer filter net | 41: inner layer filter net |
| 42: outer layer filter net | 401: residue extraction gap |

### DETAILED DESCRIPTION

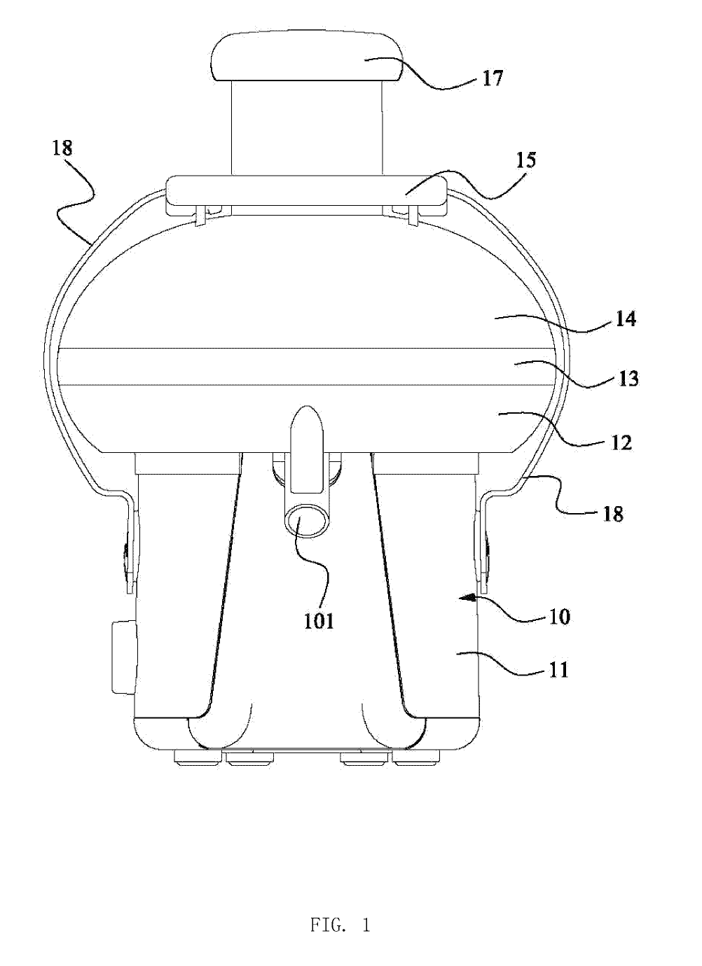

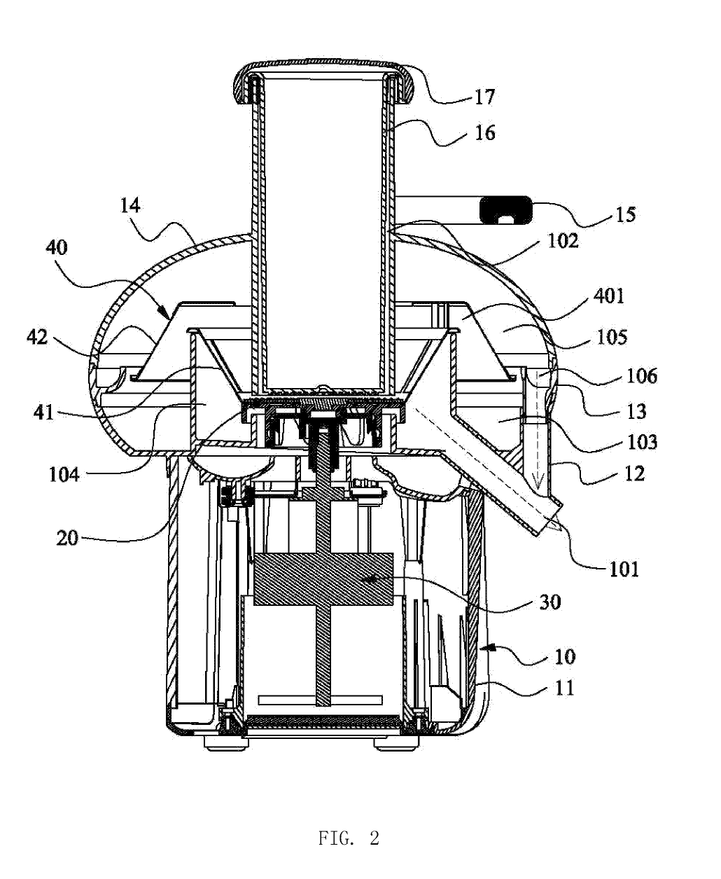

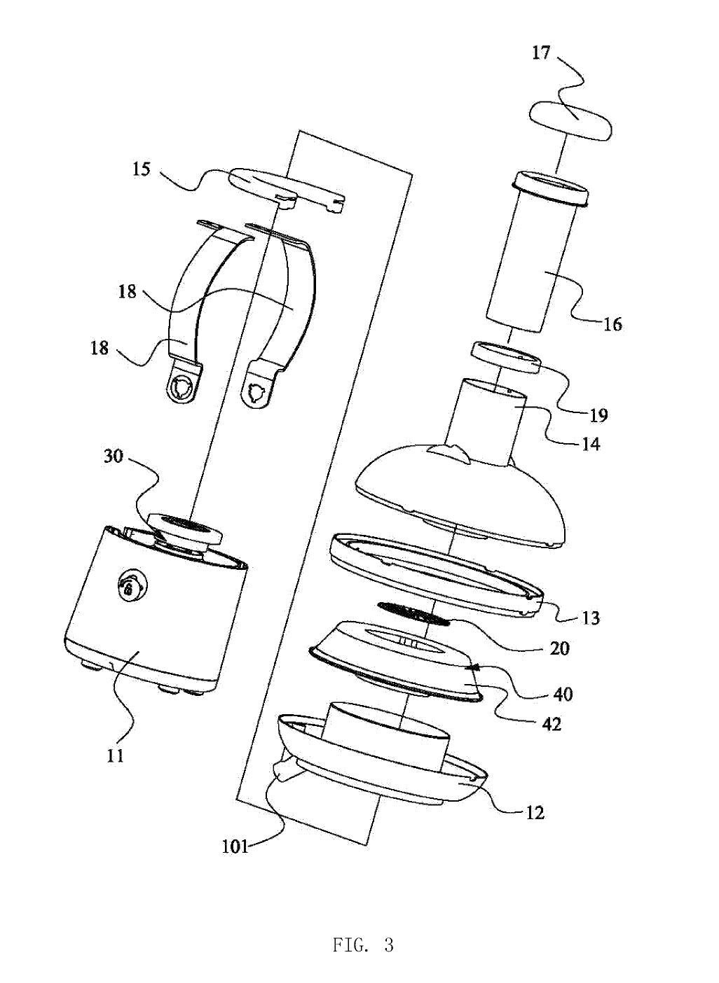

Referring to FIGS. 1-5, a juicer according to an embodiment of the present patent application includes a housing 10, a cutting plate 20, a driving device 30 and a dual-layer filter net 40.

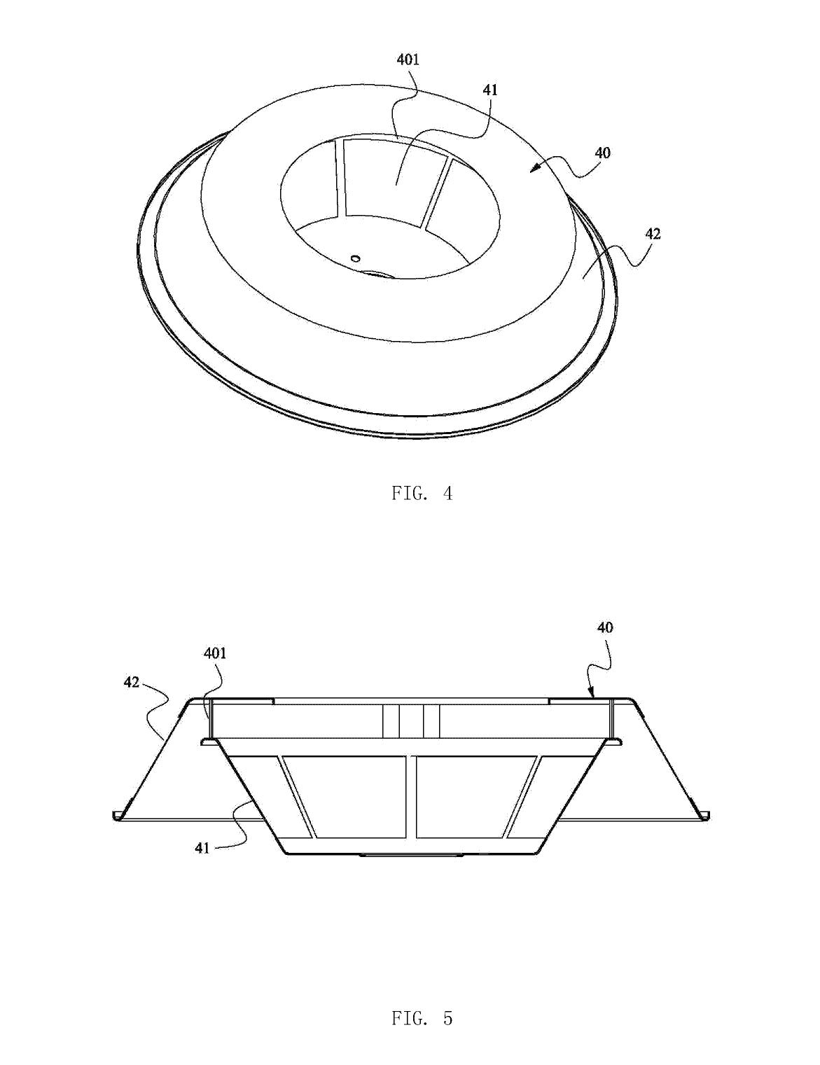

As FIG. 4 and FIG. 5 show, the dual-layer filter net 40 includes a concaved-shaped inner layer filter net 41 including a first opening facing upwards and a concaved-shaped outer layer filter net 42 including a second opening facing downwards. In the present embodiment, the inner layer filter net 41 is in a funnel shape that tapers from top to bottom. The outer layer filter net 42 is in a funnel shape that tapers from bottom to top. The maximum external diameter of the inner layer filter net 41 is less than or equal to the minimum internal diameter of the outer layer filter net 42. The outer layer filter net 42 is located at the upper part of the inner layer filter net 41. The first opening of the inner layer filter net 41 is located within the outer layer filter net 42. An external circumference of the first opening of the inner layer filter net 41 and an internal wall of the outer layer filter net 42 form a residue extraction gap 401 therebetween.

The dual-layer filter net 40, cutter plate 20 and driving device 30 are all mounted within the housing 10. The cutter plate 20 locates within the inner layer filter net 41. The driving device 30 drives the cutter plate 20 to rotate. On the housing 10 are provided with a juice extraction outlet 101, a material inlet cavity 102, a residue collecting cavity 103, a first juice collecting cavity 104, and a second juice collecting cavity 105. The material inlet cavity 102 is located at the central upper part of the cutter plate 20 and connects to the internal part of the inner layer filter net 41. The residue collecting cavity 103 locates at the lower part of the residue extraction gap 401 and connects to the residue extraction gap 401. The first juice collecting cavity 104 locates at the lower part of the inner layer filter net 41. The second juice collecting cavity 105 locates at the external area of the inner layer filter net 42. The first juice collecting cavity 104 and second juice collecting cavity 105 both connect to the juice outlet 101. The internal bottom surface of the second juice collecting cavity 105 has a ring shaped juice collecting groove 106. The external side of the interior wall surface of the ring shaped juice collecting groove 106 aligns with the external side of the interior wall surface of the second juice collecting cavity 105.

Specifically, in the present embodiment, the housing 10 includes a main body 11, a first juice collecting cap 12, a second juice collecting cap 13, an upper cap 14 and a handle 15. The driving device 30 is installed within the main body 11. The first juice collecting cap 12 is fixedly installed on the main body 11. The inner layer filter net 41 and first juice collecting cap 12 form together the first juice collecting cavity 104. The outer layer filter net 42 and first juice collecting cap 12 form the residue collecting cavity 103. The juice outlet 101 is located on the first juice collecting cap 12. The second juice collecting cap 13 is installed on the first juice collecting cap 12. The ring shaped juice collecting groove 106 is located on the second juice collecting cap 13. The upper cap 14 is installed on the second juice collecting cap 13. Further, the upper cap 14 and the second juice collecting cap 13 form a second juice collecting cavity 105. The material inlet cavity 102 is located on the upper cap 14. Within the material inlet cavity 102 is provided with a pusher rod 16. The pusher rod 16 is hollow. The upper opening of the pusher rod 16 is sealed with a cap body 17. The left and right sides of the handle 15 are installed on the main body 11 through left and right safety arms. The top most edge of the material inlet cavity 102 is provided with a material inlet tube ring 19, which couples with the pusher rod 16 and together cause a good sealing effect.

The operation of the present embodiment is as follows:

During usage, the material to be mixed is first placed within the material inlet cavity 102, and manual input of material is performed through a pressurized pusher rod 16. After initiating the driving device 30, it drives the cutter plate 20 to rotate and grinds the material. After most of the juice is filtered by the inner layer filter net 41 of the dual-layer filter net 40, it flows inside the first juice collecting cavity 104. This realizes the first juice extraction. The residues extracted from the inner layer filter net 41 contains juice which flows inside the second juice collecting cavity 105 through the outer layer filter net 42 before falling inside the residue collecting cavity 103 under the effect of the centrifugal force, so as to realize the second juice extraction. Lastly, the first juice extraction and the second juice extraction combine and flow out from the juice outlet 101, while the residue flies inside the residue collecting cavity 103 from the residue extraction gap 401.

The grinded material undergoes a first juice extraction by the inner layer filter net, and undergoes a second juice extraction with the residues expelled by the outer layer filter net. In order to prevent part of the juice being expelled with the residues, the angles between the slanted surface and horizontal surface of the inner and outer layer filter nets are different. Furthermore, the angles between the slanted surface and horizontal surface of the outer layer filter net can be adjusted freely and are not limited to the 90 degrees angle. In addition, after the residues are expelled from the inner layer filter net to the internal wall of the outer layer filter net, the centrifugal force would decelerate and the effect in the separation of the residues and juice would be satisfactory and the rate of amount of juice extraction would be high, so that waste would be minimized. This is particularly suitable for the squeezing apple, carrot, celery as such fruits and vegetables.

The present patent application can effectively solve the existing problem of waste caused from low amount of juice extracted with the use of contemporary filter net of juicers.

While there has been illustrated and described what are presently considered to be example embodiments, it will be understood by those skilled in the art that various other modifications may be made, and equivalents may be substituted, without departing from the central concept described herein. Additionally, many modifications may be made to adapt a particular situation to the teachings of claimed subject matter without departing from the central concept described herein. Therefore, it is intended that claimed subject matter not be limited to the particular embodiments disclosed, but that such claimed subject matter may also include all embodiments falling within the scope of the appended claims, and equivalents thereof.

1. A dual-layer filter net, comprising:
a concaved-shaped inner layer filter net comprising a first opening facing upwards; and
a concaved-shaped outer layer filter net comprising a second opening facing downwards;
wherein:
the outer layer filter net is located at a top of the inner layer filter net;
the first opening is located within the outer layer filter net; and
an external circumference of the first opening and an internal wall of the outer layer filter net form a residue extraction gap therebetween.

2. The dual-layer filter net of claim 1, wherein the inner layer filter net is in a funnel shape that tapers from top to bottom, and the outer layer filter net is in a funnel shape that tapers from bottom to top.

3. The dual-layer filter net of claim 2, wherein a maximum external diameter of the inner layer filter net is less than or equal to a minimum internal diameter of the outer layer filter net.

4. A juicer comprising:
a dual-layer filter net comprising:
a concaved-shaped inner layer filter net comprising a first opening facing upwards; and
a concaved-shaped outer layer filter net comprising a second opening facing downwards;
a housing comprising a juice opening, a material inlet cavity, a residue collecting cavity, a first juice collecting cavity, and a second juice collecting cavity;
a cutter plate; and
a driving device; wherein:
the outer layer filter net is located at a top of the inner layer filter net;
the first opening of the inner layer filter net is located within the outer layer filter net;
an external circumference of the first opening of the inner layer filter net and an internal wall of the outer layer filter net form a residue extraction gap therebetween;
the dual-layer filter net, cutter plate and driving device are mounted inside the housing;
the cutter plate is located within the inner layer filter net;
the driving device is configured to drive the cutter plate to rotate;
the material inlet cavity is located at a central top of the cutter plate and connects to an internal part of the inner layer filter net;
the residue collecting cavity is located at a bottom of the residue opening gap and connects to the residue opening gap;
the first juice collecting cavity is located at a bottom of the inner layer filter net;
the second juice collecting cavity is located at an external area of the outer layer filter net; and
the first juice collecting cavity and the second juice collecting cavity both connect to the juice opening.

5. The juicer of claim 4, wherein an internal bottom surface of the second juice collecting cavity comprises a ring shaped juice collecting groove, and an external side of an inner wall surface of the ring shaped juice collecting groove aligns with an external side of an inner wall surface of the second juice collecting cavity.

6. The juicer of claim 4, further comprising a pusher rod being provided in the material inlet cavity.

7. The juicer of claim 4, wherein the inner layer filter net is in a funnel shape that tapers from top to bottom, and the outer layer filter net is in a funnel shape that tapers from bottom to top.

8. The juicer of claim 4, wherein a maximum external diameter of the inner layer filter net is less than or equal to a minimum internal diameter of the outer layer filter net.
